(19) United States
(12) Patent Application Publication
(10) Pub. No.: US 2008/0244924 A1
(43) Pub. Date: Oct. 9, 2008

(54) Drying method and apparatus for use of latent heat

(76) Inventors: Chang-Ren Chen, Chia-Yi City (TW); Juh-Ping Chang, Yung-Kung City (TW); Huann-Ming Chou, Yongkang City (TW); Rong-Fang Hong, Tainan (TW); Atul Sharma, Yung-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,590

(22) Filed: Apr. 3, 2007

(51) Int. Cl. F26B 3/28

(52) U.S. Cl. 34/522; 34/93

(57) ABSTRACT

A drying method for use of latent heat includes the following steps: A. installing a heating plate and a latent heat device having wax in a dry environmental space; B. placing an article to be dried in the dry environmental space; C. absorbing outside heat energy with the heating plate for drying process; D. utilizing the latent heat device to accumulate heat energy; and E. releasing the heat energy from the latent heat device for drying process. A drying apparatus for use of latent heat includes a box, a heating plate provided on the box, and a latent heat device provided in the box. The box has an entrance and a vent. The entrance is provided with a door to seal the entrance. The latent heat device comprises wax therein to do heat exchange through for drying purpose.

### BACKGROUND OF THE INVENTION

1. Field of the Invention

The present invention relates to a drying method and apparatus for use of latent heat, in particular to one utilizing a latent heat device provided with wax to do heat exchange in a dry environment. The present invention saves energy without pollution, is cost-effective, and will not be influenced by the condition of the weather.

2. Description of the Prior Art

There are a few drying methods on the market, such as electric heaters, vapor or natural wind drying methods. All of which have shortcomings. The electric heaters require a lot of energy. The vapor drying method is not cost-effective. The natural wind drying method requires a long period to dry an object, and is easily influenced by the weather condition.

### SUMMARY OF THE INVENTION

It is the primary object to provide a drying method and apparatus for use of latent heat, which uses a heat exchange method to dry an article without being affected by the weather.

It is another object of the present invention to provide a drying method and apparatus for use of latent heat, which does not consume energy, is cost-effective, and corresponds to the environmental requirement.

According to the present invention, there is provided with a drying method for use of latent heat comprising the steps of: A. installing a heating plate and a latent heat device having wax in a dry environmental space; B. placing an article to be dried in the dry environmental space; C. absorbing outside heat energy with the heating plate for drying process; D. utilizing the latent heat device to accumulate heat energy; and E. releasing the heat energy from the latent heat device for drying process, wherein the steps of C, D, and E are repeated continuously.

According to the present invention, there is provided with a drying apparatus for use of latent heat comprising a box, a heating plate provided on the box, and a latent heat device provided in the box. The box has an entrance and a vent. The entrance is provided with a door to seal the entrance. The latent heat device comprises wax therein to do heat exchange through for drying purpose.

### BRIEF DESCRIPTION OF THE DRAWINGS

FIG. 1 is a block diagram of drying steps of the present invention;

FIG. 2 is a perspective view of a drying apparatus of the present invention; and

FIG. 3 is a side view of the drying apparatus of the present invention in an operating status.

### DETAILED DESCRIPTION OF THE PREFERRED EMBODIMENT

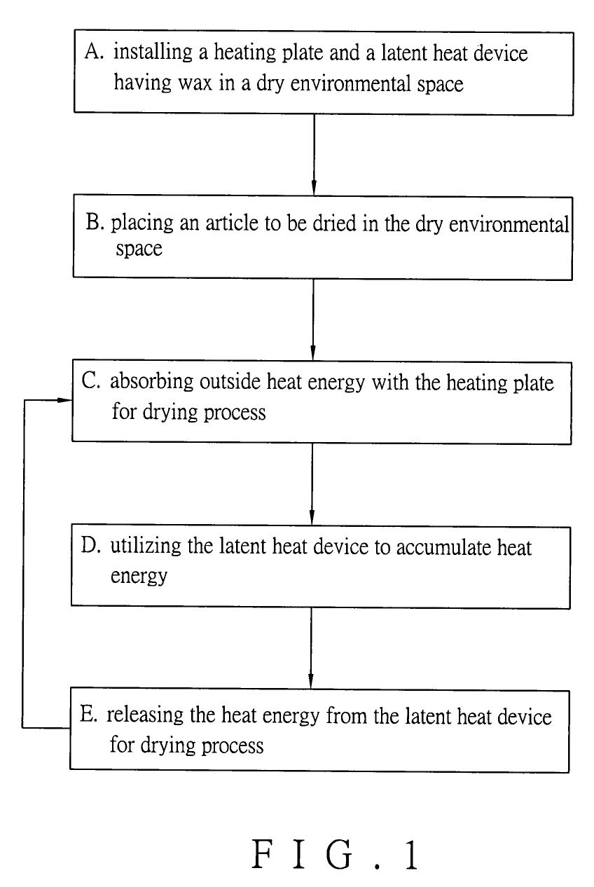

A drying method for use of latent heat, as shown in FIG. 1, comprises the following steps:
A. installing a heating plate and a latent heat device having wax in a dry environmental space;
   The heating plate is able to absorb solar energy and the latent heat device comprises wax therein; the melting point of the wax is between 30 and 120 degrees centigrade, depending on its ingredient.
B. placing an article to be dried into the dry environmental space;
   The article is placed into the dry environmental space; the dry environmental space is provided with vents to maintain an appropriate humidity in the dry environmental space; the number of the vents corresponds to the condition of the dry environmental space.
C. collecting outside heat energy with the heating plate to do drying process;
   The heating plate is able to collect solar energy to produce heat energy to dry the article placed in the dry environmental space.
D. utilizing the latent heat device to accumulate heat energy;
   When the temperature in the drying environmental space reaches to the melting point of the wax in the latent heat device, the wax will start to melt to accumulate heat energy.
E. releasing heat energy from the latent heat device to dry the article.
   When the temperature in the dry environmental space is lower than the melting point of the wax, the wax will solidify to release heat energy to dry the article in the dry environmental space.

By repeating the steps C. D. and E, the drying process can be done continuously without stopping. The present invention saves energy without pollution, and will not be influenced by the weather condition.

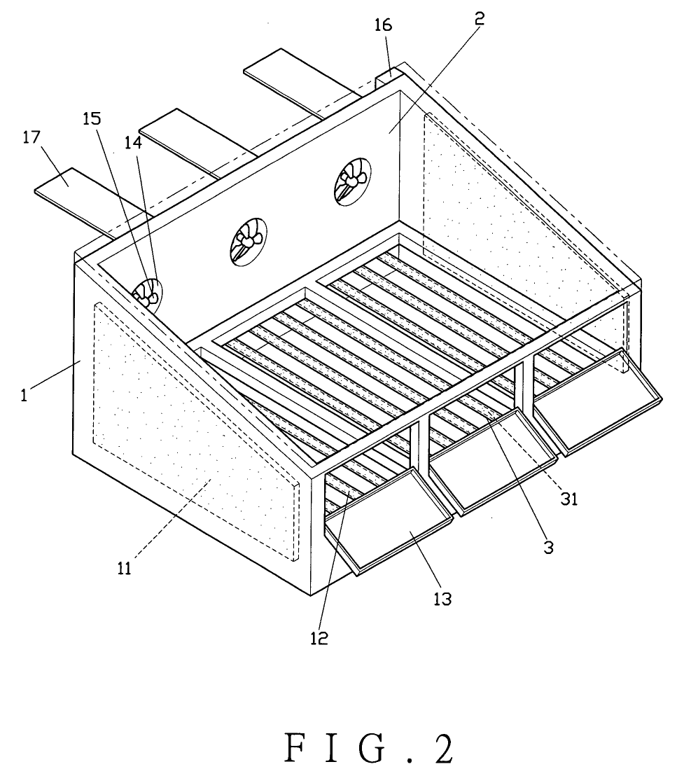

A drying apparatus for use of latent heat, as shown in FIG. 2 comprises a box (1), a heating plate (2), and a latent heat device (3).

The box (1) is a sealed space with wax (11) filled in the wall of the box (1). The wall outer surface of the box (1) is made of heat insulation material to prevent heat energy in the box (1) from dispensing. The box (1) further comprises at least one entrance (12) at one side thereof. The entrance (12) is provided with a door (13) to seal the entrance (12). At least one vent (14) is formed at another side of the box (1). The vent (14) is provided with an exhaust fan (15). The exhaust fan (15) is controlled by a humidity controller (16) to start or to stop the exhaust fan (15), depending on the humidity in the box (1). The vent (14) is provided with a shelter (17) adapted to seal the vent (14) when necessary.

The heating plate (2) is provided at the top of the box (1), and is adapted to absorb solar energy to produce heat energy.

The latent heat device (3) is provided at the bottom of the box (1). The latent heat device (3) is in the shape of a tube having wax (31) therein to absorb heat energy and to do heat exchange through air.

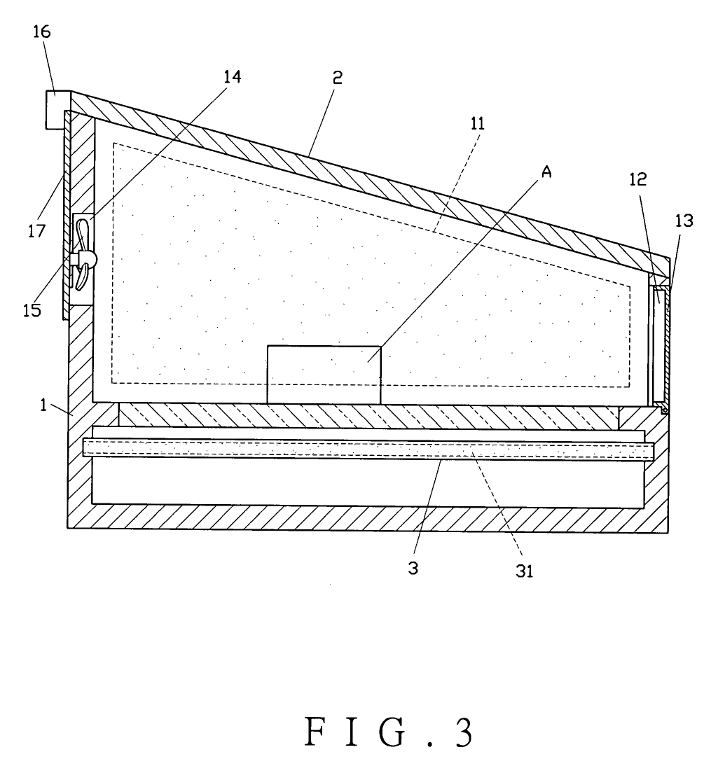

As shown in FIG. 3, an article (A) to be dried is placed into the box (1) through the entrance (12). The door (13) is closed to seal the entrance (12). When the sun is shining, the heating plate (2) will absorb solar energy to produce heat energy so as to dry the article (A) in the box (1). The heat energy is to do heat exchange with the wax (1) in the wall of the box (1) and the wax (31) in the latent heat device (3) through the air in the box (1). When the temperature reaches to the melting point of the wax (11, 31), the wax (11, 31) will melt to do heat exchange through the air in the box (1) to accumulate heat energy. The humidity controller (16) has a preset value. If the humidity in the box (1) should reach to its limit, the humidity controller (16) will start the exhaust fan (15) to expel the hydrosphere from of the box (1) through the vent (14) so as to maintain an appropriate humidity in the box (1).

When it is nighttime or the weather condition is bad, the temperature in the box (1) is lower than the melting point of the wax (11, 31), the wax (11, 31) will start to solidify and release its heat energy to dry the article (A) in the box (1). The shelter (17) is to seal the vent (14) to prevent water or humidity from penetrating into the box (1). With the circulation of day and night, the drying procedure can be done without being interrupted by the weather condition.

What is claimed is:

1. A drying method for use of latent heat, comprising the following steps:
A. installing a heating plate and a latent heat device having wax in a dry environmental space;
B. placing an article to be dried in the dry environmental space;
C. absorbing outside heat energy with the heating plate for drying process;
D. utilizing the latent heat device to accumulate heat energy; and
E. releasing the heat energy from the latent heat device for drying process.

2. The drying method for use of latent heat, as recited in claim 1, wherein the steps of C, D, and E are repeated continuously.

3. A drying apparatus for use of latent heat, comprising:
a box having at least one entrance and at least one vent, the entrance being provided with a door to seal the entrance;
a heating plate provided on the box; and
a latent heat device provided in the box, the latent heat device comprising wax therein to do heat exchange through air.

4. The drying apparatus for use of latent heat, as recited in claim 3, wherein the box has a wall filled with wax.

5. The drying apparatus for use of latent heat, as recited in claim 4, wherein the wax has a melting point between 30 through 120 degrees centigrade.

6. The drying apparatus for use of latent heat, as recited in claim 3, wherein the vent of the box is provided with an exhaust fan.

7. The drying apparatus for use of latent heat, as recited in claim 6, wherein the exhaust fan is controlled by a humidity controller.

8. The drying apparatus for use of latent heat, as recited in claim 3, the vent of the box is provided with a shelter.
